(19) United States
(12) Patent Application Publication
(10) Pub. No.: US 2016/0345538 A1
(43) Pub. Date: Dec. 1, 2016

(54) Drinking Device

(71) Applicant: Mark Crawford, Damascus, OR (US)

(72) Inventor: Mark Crawford, Damascus, OR (US)

(21) Appl. No.: 15/095,237

(22) Filed: Apr. 11, 2016

Related U.S. Application Data
(60) Provisional application No. 62/167,643, filed on May 28, 2015.

(51) Int. Cl. A01K 7/00

(52) U.S. Cl. CPC A01K 7/00

(57) ABSTRACT

A drinking device for allowing a pet to more easily drink from a faucet. The drinking device includes a body having a rear end that tapers towards a front end. The body includes an interior volume in which water can collect and flow. The body includes sidewalls about the periphery thereof that extend from the rear end toward the front end, wherein the front end is open so that water can flow outward therefrom. A hook extends upwardly from the rear end of the body and is adapted to be positioned over a faucet so that the body is positioned directly under the faucet. A fastener is provided for securing the hook onto the faucet while the drinking device is in use.

### CROSS REFERENCE TO RELATED APPLICATION

This application claims the benefit of U.S. Provisional Application No. 62/167,643 filed on May 28, 2015. The above identified patent application is herein incorporated by reference in its entirety to provide continuity of disclosure.

### BACKGROUND OF THE INVENTION

### Field Of The Invention

The present invention relates to drinking devices. More specifically, the present invention provides a drinking device for allowing a pet to more easily drink from a faucet.

Many pets enjoy drinking water directly from a flowing water source rather than from a bowl filled with still water. As a result, many pet owners will allow their pets to drink from the faucet of a sink, such as in the kitchen or bathroom. However, the sink is often too small to accommodate a pet's body therein and the downward flow of water from the faucet may make it difficult for the pet to drink from the sink. As a result, the pet may struggle to drink from the sink as the water flows therefrom.

Devices have been disclosed in the prior art that relate to drinking devices for pets. These include devices that have been patented and published in patent application publications. These devices generally relate to sink faucet devices for use by pets, such as U.S. Pat. No. 7,987,817 and U.S. Published Patent Application Number 2010/0139790. Other devices relate to pet water fountains, such as U.S. Pat. No. 7,089,881, U.S. Pat. No. 6,279,508, and U.S. Published Patent Application Number 2007/0095297.

These prior art devices have several known drawbacks. The devices in the prior art fail to provide a drinking device that can be removably secured to a faucet so as to divert water from the faucet to allow a pet to easily drink therefrom. This allows the user to easily connect the drinking device for use by the pet and then remove the same when the pet is finished drinking so that the faucet can be utilized in the conventional manner.

In light of the devices disclosed in the prior art, it is submitted that the present invention substantially diverges in design elements from the prior art and consequently it is clear that there is a need in the art for an improvement to existing drinking devices. In this regard the instant invention substantially fulfills these needs.

### SUMMARY OF THE INVENTION

In view of the foregoing disadvantages inherent in the known types of drinking devices now present in the prior art, the present invention provides a new drinking device wherein the same can be utilized for providing convenience for the user when allowing a pet to drink from a faucet.

The pet drinking device comprises a body having a rear end that tapers towards a front end. The body defines an interior volume in which water can collect and flow. The body includes sidewalls extending around the body from the rear end thereof towards the front end, wherein the front end is open so that water can flow therefrom. A hook extends upwardly from the rear end of the body and is adapted to be positioned over a faucet so that the body is disposed directly thereunder. A fastener is provided for securing the hook onto the faucet while the device is in use.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the drinking device.

FIG. 2 shows a top-down view of the drinking device.

FIG. 3 shows a front perspective view of the drinking device secured to a faucet.

FIG. 4A shows a side view of a first embodiment of the drinking device.

FIG. 4B shows a side view of a second embodiment of the drinking device.

FIG. 4C shows a side view of a third embodiment of the drinking device.

### DETAILED DESCRIPTION OF THE INVENTION

Reference is made herein to the attached drawings. Like reference numerals are used throughout the drawings to depict like or similar elements of the drinking device. For the purposes of presenting a brief and clear description of the present invention, the preferred embodiment will be discussed as used for allowing a pet to more easily drink directly from a running faucet. The figures are intended for representative purposes only and should not be considered to be limiting in any respect.

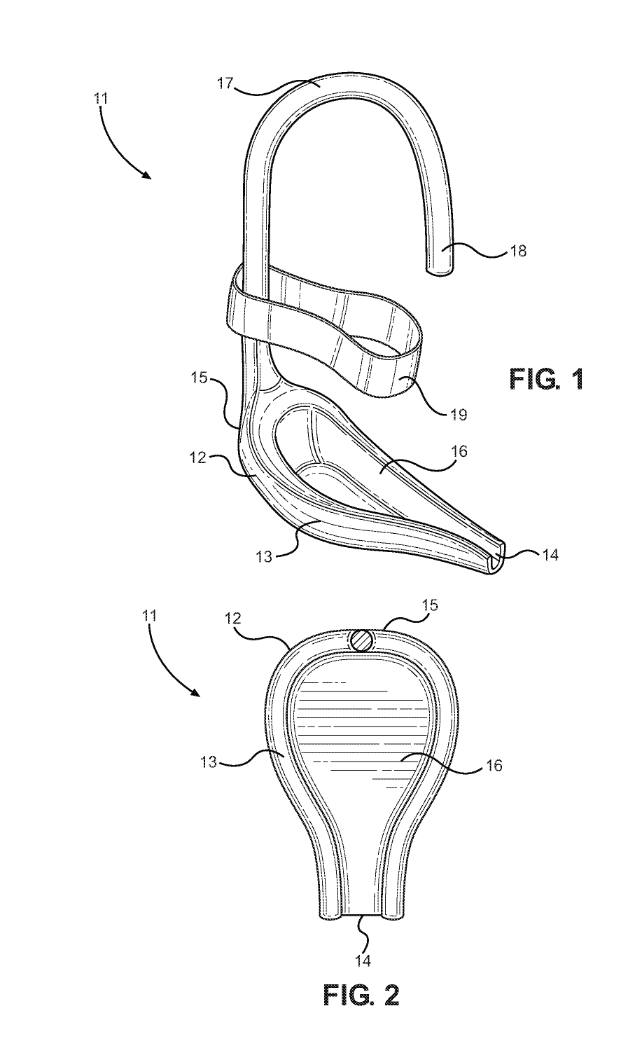

Referring now to FIGS. 1 and 2, there is shown a front perspective view of the drinking device and a top down view of the body of the drinking device, respectively. The drinking device 11 comprises a body 12 adapted to collect water and divert the flow of water so that a pet can drink therefrom. The body 12 includes a front end 14 and a rear end 15. The body tapers from the rear end 15 towards the front end 14 so as to channel the water towards the front end 14. The body 12 includes sidewalls 13 extending from the rear end 15 towards the front end 14, wherein the front end 14 is open. The sidewalls 13 define an interior volume 16 in which water can collect and flow, wherein the water escapes the body 12 from the front end 14 thereof. The body 12 preferably comprises an arcuate configuration including a rounded rear end 15.

A hook 17 extends upwardly from the rear end 15 of the body 12. The hook includes a vertical portion and includes an inverted U-shape extending from the vertical portion so that the hook can be positioned over a faucet. The hook 17 is positioned such that it extends over the body 12 so that it is disposed directly thereabove. The hook 17 is preferably composed of a rigid or semi-rigid material so that it maintains its shape and holds the body 12 in a stable position when secured on a faucet as water flows thereover. In some embodiments, the hook 17 is removably secured to the body 12 so that the hook 17 and body 12 can be separated for cleaning.

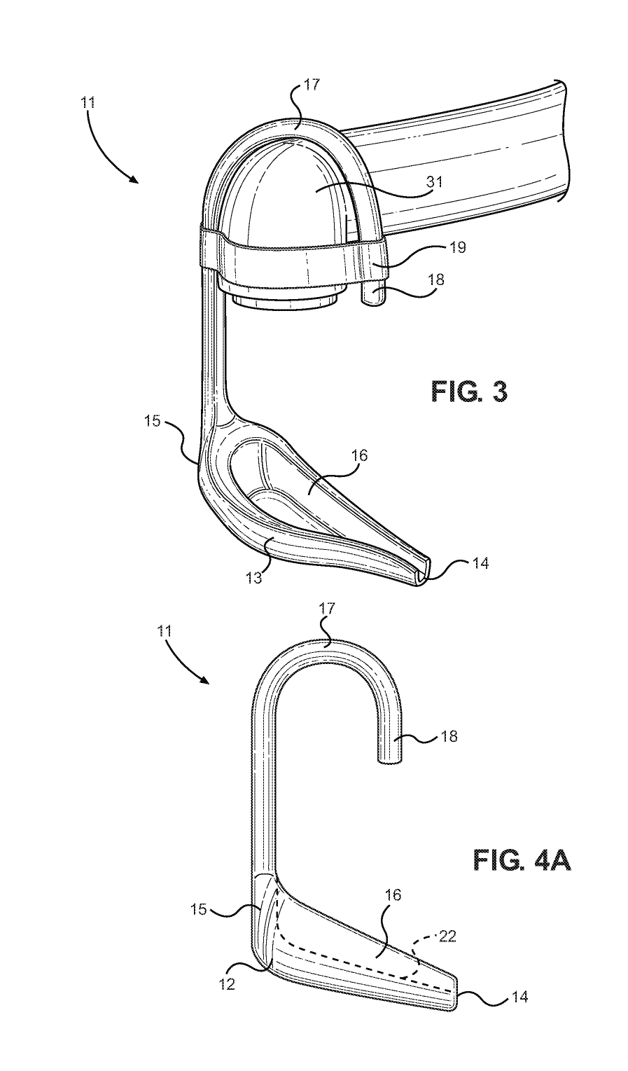

Referring now to FIG. 3, there is shown a perspective view of the drinking device as secured on a faucet. In operation, the hook 17 is disposed over the end of a faucet 31 so as to secure the drinking device 11 thereon. The hook 17 is adapted to extend laterally across the faucet 31. When the drinking device 11 is secured to the faucet 31, the body 12 extends in a horizontal orientation wherein the interior volume 16 thereof is located directly under the faucet 31 so that when the faucet 31 is turned on, water will flow into the interior volume 16 and out from the open front end 14 of the body 12 in a lateral direction.

A fastener 19 is provided for securing the hook 17 onto the faucet 31 so that the drinking device 11 does not fall or slip from the faucet 31. The fastener 19 is preferably an elastic band. The elastic band is adapted to be positioned so as to encircle an upstanding portion of the hook that is connected to the rear end 15 of the body 12 and around the distal end 18 of the hook 17. In this way, the elastic band creates tension to hold the hook 17 in position over the faucet 31.

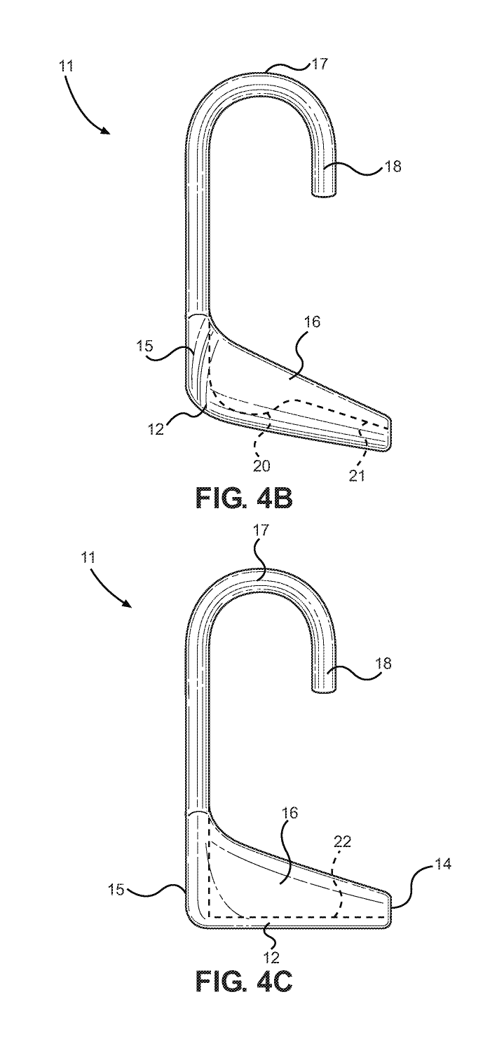

Referring now to FIG. 4A, there is shown a first embodiment of the drinking device. In the illustrated embodiment, the interior volume 16 includes a sloped lower wall 22. The lower wall 22 slopes downwardly from the rear end 15 thereof towards the front end 14 thereof. This helps to channel the water that flows into the interior volume 16 towards the front end 14 thereof. This creates a steady flow of water through the body 12.

Referring now to FIG. 4B, there is shown a second embodiment of the drinking device. In the illustrated embodiment, the lower wall forms a bowl region 20 located towards the rear end 15 of the body 12 and a sloped region 21 towards the front end 14 thereof. The bowl region 20 serves to collect a volume of water therein so that the pet can drink therefrom. The bowl region 20 has a greater depth that the remainder of the interior volume. The front end 14 of the interior volume 16 slopes downwardly from the bowl region 20 so as to allow water to flow from the front end 14 thereof.

Referring now to FIG. 4C, there is shown a third embodiment of the drinking device. In the illustrated embodiment, the interior volume 16 includes a flat lower wall 22. The flat lower wall 22 allows water to collect within the interior volume 16 of the body 12 and slowly flow towards the front end 14. The flat lower wall 22 results in a slower flow of water than the downwardly sloped lower wall, which may allow a pet to drink more easily from the interior volume of the body 12.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A drinking device for a pet, comprising:
a body having a rear end and a front end, wherein the body tapers from the rear end towards the front end thereof;
the body having an interior volume defined by one or more sidewalls extending from the rear end towards the front end such that the front end is open;
a hook extending upwardly from the rear end of the body, wherein the hook is adapted to be secured over a faucet, such that water dispensed by the faucet flows into the interior volume of the body.

2) The drinking device of claim 1, wherein the hook is positioned such that the hook is disposed directly over the body.

3) The drinking device of claim 1, wherein the interior volume comprises a lower wall that is sloped downwardly from the rear end towards the front end of the body.

4) The drinking device of claim 1, wherein the interior volume comprises a bowl region adapted to allow water to collect therein.

5) The drinking device of claim 1, wherein the interior volume comprises a flat lower wall.

6) The drinking device of claim 1, further comprising a fastener adapted to removably secure the hook to the faucet.

7) The drinking device of claim 6, wherein the fastener is an elastic band.

8) A drinking device for a pet, comprising:
a body having a rear end and a front end, wherein the body tapers from the rear end towards the front end thereof;
the body having an open upper end and an interior volume defined by one or more sidewalls extending from the rear end towards the front end such that the front end is open and allows water to flow out from the interior volume of the body;
a hook extending upwardly from the rear end of the body, wherein the hook is positioned directly above the body, wherein the hook includes a U-shaped configuration such that the hook is adapted to be secured over a faucet so that water dispensed by the faucet flows into the interior volume of the body for consumption by a pet.

9) The drinking device of claim 8, wherein the body has a bowl-shaped configuration.

10) The drinking device of claim 8, wherein the sidewall extends around the perimeter of the body.

11) The drinking device of claim 8, wherein the interior volume includes a lower wall 1that is substantially flat.

12) The drinking device of claim 8, wherein the interior volume includes a lower wall that slopes from the rear end towards the front end of the body.

13) The drinking device of claim 8, wherein the interior volume includes a bowl region at the rear end thereof.
